(19) United States
(12) Patent Application Publication
(10) Pub. No.: US 2017/0168900 A1
(43) Pub. Date: Jun. 15, 2017

(54) USING DECLARATIVE CONFIGURATION DATA TO RESOLVE ERRORS IN CLOUD OPERATION

(71) Applicant: Microsoft Technology Licensing, LLC, Redmond, WA (US)

(72) Inventors: Shawn Michael Lucas, Bellevue, WA (US); Cheng Wei, Bellevue, WA (US); Rahim Maknojia, Redmond, WA (US); Robert S.T. Gibson, Duvall, WA (US); Matthew C. Wetmore, Redmond, WA (US)

(21) Appl. No.: 15/055,511

(22) Filed: Feb. 26, 2016

Related U.S. Application Data
(60) Provisional application No. 62/267,263, filed on Dec. 14, 2015.

(51) Int. Cl. G06F 11/14

(52) U.S. Cl. CPC G06F 11/1417; G06F 11/1441; G06F 2201/805; G06F 2201/85

(57) ABSTRACT

Aspects extend to methods, systems, and computer program products for using declarative configuration data to resolve errors in cloud operation. A tool (e.g., a maintenance module) and a design model can be used for bootstrapping a cloud stack that enables an external media based deployment model. The deployment model allows provisioning of an entire cloud stack as well as reset of or recovery from a failure of an existing cloud deployment instance. In one aspect, a bootstrap command for a cloud, a recovery command for the cloud, and a reset command for the cloud are consolidated within declarative configuration data. The tool (e.g., the maintenance module) can refer to the declarative configuration data to implement any of the bootstrap command, the recovery command, or the reset command.

### CROSS-REFERENCE TO RELATED APPLICATIONS

This application claims the benefit of U.S. Provisional Patent Application Ser. No. 62/267,263, entitled “USING DECLARATIVE CONFIGURATION DATA TO IMPLEMENT CLOUD OPERATIONS”, filed Dec. 14, 2015, which is incorporated herein in its entirety.

### BACKGROUND

### 1. Background and Relevant Art

Computer systems and related technology affect many aspects of society. Indeed, the computer system's ability to process information has transformed the way we live and work. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments. For example, distributed applications can have components at a number of different computer systems.

In some environments, a group of resources is configured in a “cloud”. Often, resources in a data center are grouped and configured into a cloud for use by a customer or other user. As such, cloud computing provides users and enterprises with various capabilities to process and store their data in third-party data centers.

However, configuring and reconfiguring a cloud can be a highly technical and complex process. Each user or enterprise may desire to use a different configuration of hardware and software components. Different configurations can cause different hardware and software components to be dependent on one another. If operations related to dependent hardware and software resources are not executed in an appropriate sequence, a resulting cloud may not function as intended. Further, a user or enterprise may desire to change cloud configuration overtime. Changing configuration can also change component dependencies. As such, a user or enterprise may be constantly challenged with managing new and evolving component dependencies within their cloud.

Unfortunately, it can be extremely difficult for a user or enterprise to be aware of all possible dependencies between a group of hardware and software components to be utilized in a cloud. Even developers of hardware and/or software components may be aware of only some dependencies for their components. Thus, each time a cloud configuration change is desired, (potentially extensive) experimentation may be needed to resolve dependencies and settle on intended cloud functionality. The experimentation can be time consuming resulting in downtime for a user or enterprise.

Additionally, when a cloud experiences operational errors, it can be difficult to transition the cloud back to a functional state. A corrective process can include a high number of manual operations. Further, depending on the error, different tools for implementing one or more different corrective processes may be required. As such, each different corrective process can be implemented through one or more separate different tools and/or through a different set of documented manual instructions. For example, booting strapping a cloud, resetting a cloud, and recovering a cloud can all be different processes implemented by one or more different tools and/or different documented manual instructions.

### Brief Summary

Examples extend to methods, systems, and computer program products for using declarative configuration data to resolve errors in cloud operation. A request to implement a corrective command for a cloud is received the corrective command for correcting inappropriate operation of the cloud.

Aggregate declarative configuration data defining configuration for the cloud is accessed. The aggregate declarative configuration data includes one or more declared roles and one or more declared action plans. Each of the one or more declared roles is usable in the cloud and includes one or more interfaces for functions corresponding to one or more corrective commands Each of the one or more functions is associated with an executable script. Each of the one or more declared action plans including a sequence of execution for implementing a corresponding corrective command through reference to at least one interface in at least one declared role.

The aggregate declarative configuration data is referred to to identify an action plan, from among the one or more action plans, corresponding to the requested corrective command. The identified action plan specifies a sequence of execution for executing a plurality functions from one or more declared roles. Corrective actions are performed in the cloud to attempt to correct the inappropriate operation of the cloud in accordance with the corrective command. The corrective operations are performed by executing scripts. The scripts accessed by cross-referencing each of the plurality of functions in accordance with the specified sequence of execution to implement the corrective operations.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 illustrates an example architecture that facilitates using declarative configuration data to resolve errors in cloud operation.

FIG. 2 illustrates a flow chart of an example method for using declarative configuration data to resolve errors in cloud operation.

FIGS. 3A and 3B illustrate example aggregate declarative configuration data.

### DETAILED DESCRIPTION

Examples extend to methods, systems, and computer program products for using declarative configuration data to resolve errors in cloud operation. A request to implement a corrective command for a cloud is received the corrective command for correcting inappropriate operation of the cloud.

Aggregate declarative configuration data defining configuration for the cloud is accessed. The aggregate declarative configuration data includes one or more declared roles and one or more declared action plans. Each of the one or more declared roles is usable in the cloud and includes one or more interfaces for functions corresponding to one or more corrective commands Each of the one or more functions is associated with an executable script. Each of the one or more declared action plans including a sequence of execution for implementing a corresponding corrective command through reference to at least one interface in at least one declared role.

The aggregate declarative configuration data is referred to to identify an action plan, from among the one or more action plans, corresponding to the requested corrective command. The identified action plan specifies a sequence of execution for executing a plurality functions from one or more declared roles. Corrective actions are performed in the cloud to attempt to correct the inappropriate operation of the cloud in accordance with the corrective command. The corrective operations are performed by executing scripts. The scripts accessed by cross-referencing each of the plurality of functions in accordance with the specified sequence of execution to implement the corrective operations.

Implementations may comprise or utilize a special purpose or general-purpose computer including computer hardware, such as, for example, one or more processors (including Central Processing Units (CPUs) and/or Graphical Processing Units (GPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) for any of a plurality of described operations. The one or more processors can access information from system memory and/or store information in system memory. The one or more processors can transform information between different formats.

System memory can be coupled to the one or more processors and can store instructions (e.g., computer-readable instructions, computer-executable instructions, etc.) executed by the one or more processors. The system memory can also be configured to store any of a plurality of other types of data generated by the described components.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, pagers, watches, fitness monitors, eye glasses, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

In this description and the following claims, a “hybrid cloud” is defined as composition of two or more clouds (e.g., private, community or public) that remain distinct entities but are bound together, offering the benefits of multiple deployment models. A hybrid cloud service can cross isolation and provider boundaries, allowing extension of the capacity and/or the capability of one cloud service, by aggregation, integration, or customization with another cloud service.

In one aspect, a hybrid cloud includes a private cloud and a public cloud. An entity can configure the private cloud on compute resources, networking resources, and storage resources owned by the entity. The entity can also configure a public cloud on public compute resources, networking resources, and storage resources owned by 3^{rd} party. In one aspect, the public cloud is configured essentially on demand, in anticipation of or when workloads within the private cloud exceed allocated resource capabilities. The private cloud and public cloud can be configured using the same cloud stack so that workloads can be easily transitioned from the private cloud and the public cloud and vice versa.

Aspects of the invention include a declarative language for cloud computing. The declarative language can be used to declare physical and logical topology as well as cloud operation commands at multiple topology hierarchies. Developers of different cloud components can declare roles and cloud operations in compliance with a declaration model. Compliance with the declaration model allows aggregation and cross-referencing among commands and topology elements declared by different developers. Compliance with the declaration model also facilitates interoperability with a configuration engine for declarations made by different developers. As such, dependencies between components can be efficiently identified and accounted for when implementing cloud operation commands.

Further, declarative configuration data can be used to onboard additional components to a cloud without code changes to an underlying configuration engine.

Aspects of the invention include a tool (e.g., a maintenance module) and design model for bootstrapping a cloud stack that enables an external media based deployment model. The deployment model allows provisioning of an entire cloud stack as well as reset of or recovery from failure of an existing cloud deployment instance. In one aspect, a bootstrap command for a cloud, a recovery command for the cloud, and a reset command for the cloud are consolidated within declarative configuration data. The tool (e.g., the maintenance module) can refer to the declarative configuration data to implement any of the bootstrap command, the recovery command, or the reset command.

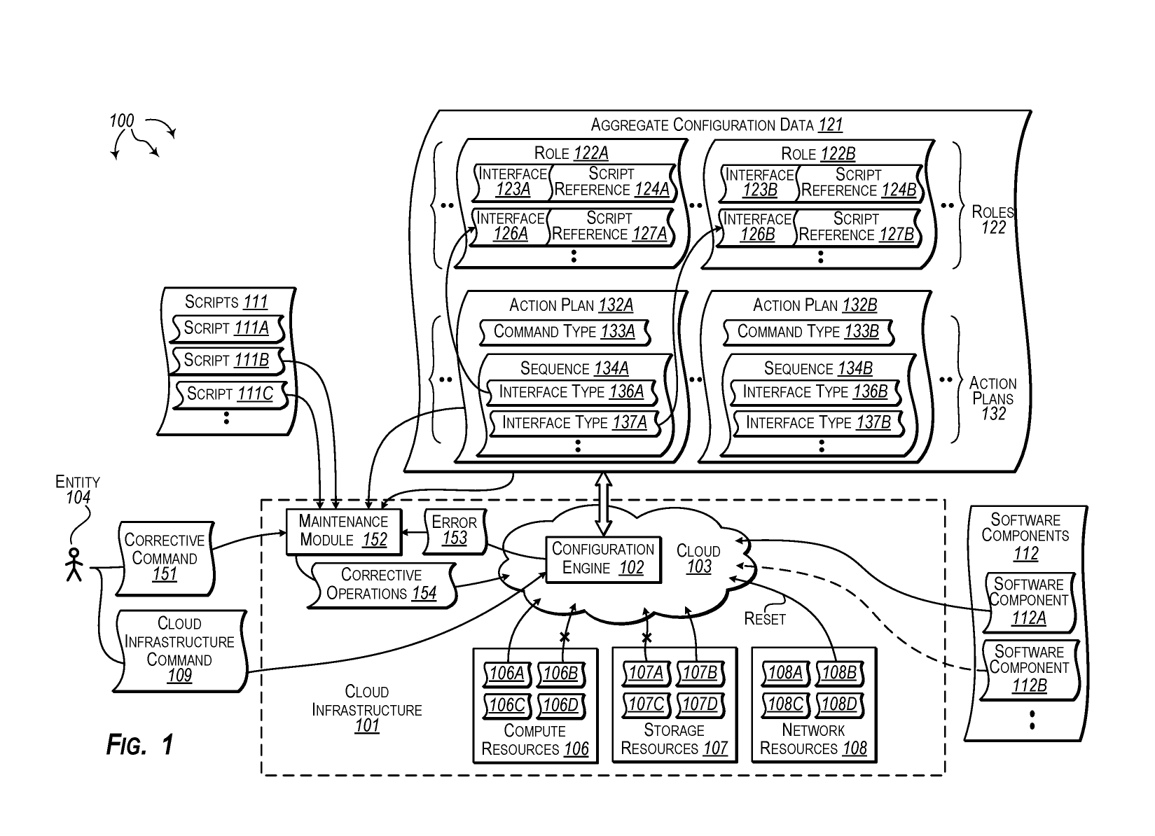

FIG. 1 illustrates an example computer architecture 100 that facilitates using declarative configuration data to resolve errors in cloud operation. Referring to FIG. 1, computer architecture 100 includes cloud infrastructure 101. Cloud infrastructure 101 can be connected to (or be part of) a network, such as, for example, a Local Area Network (“LAN”), a Wide Area Network (“WAN”), and even the Internet. Accordingly, cloud infrastructure 101 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Cloud infrastructure 101 includes maintenance module 152, computer resources 106, storage resources 107, and network resources 108. Computer resources 106, storage resources 107, and network resources 108 can be physically located in one or more data centers. In one aspect, entity 104 owns cloud infrastructure 101. In another aspect, some other entity owns cloud infrastructure 101.

Entities can send commands to cloud infrastructure 101 requesting instances of a cloud within cloud infrastructure 101. The entities can be associated with or separate from the owner of cloud infrastructure 101. In response, one or more entity created clouds, including cloud 103 (e.g., a private cloud portion or a public cloud portion of a hybrid cloud), can be instantiated within cloud infrastructure 101. Portions of compute resources 106, storage resources 107, and network resources 108 can be allocated for each cloud. For example, compute resources 106A and 106B, storage resources 107A and 107B, and network resources 108B can allocated for cloud 103.

Software components can be run on clouds instantiated within cloud infrastructure 101. For example, software components from among software components 112, including software component 112A, can be running on cloud 103.

As depicted, cloud 103 includes configuration engine 102. In general, configuration engine 102 is configured to receive cloud infrastructure commands, such as, for example, cloud infrastructure command 109. In response to receiving cloud infrastructure commands, configuration engine 102 can refer to aggregate declarative configuration data to determine how to implement the cloud infrastructure commands within cloud 103. For example, configuration engine 102 can refer to aggregate configuration data 121 to determine how to implement cloud infrastructure command 109 within cloud 103. Cloud infrastructure command 109 can be, for example, a configuration command or lifecycle command.

In general, maintenance module 152 can attempt to resolve errors in the operation of cloud 103 (and other clouds instantiated in cloud infrastructure 101). In response to a corrective command, maintenance module 152 can refer to aggregate configuration data to determine how implement the corrective command within cloud 103 (or another cloud in cloud infrastructure 101).

In one aspect, maintenance module 152 monitors one or more aspects of cloud 103 and detects when errors or other inappropriate or unintended operations occur in cloud 103. In another aspect, components within cloud 103 can indicate errors or other inappropriate or unintended operations to maintenance module 152. Maintenance module 152 can indicate to entity 104 when an error or other inappropriate or unintended operations are occurring or have occurred. In response, entity 104 can send a corrective command (e.g., for a bootstrap, a reset, or a recovery) to maintenance module 152. Maintenance module 152 can refer to aggregate configuration data and implement declared correction operations for (and potentially within) cloud 103.

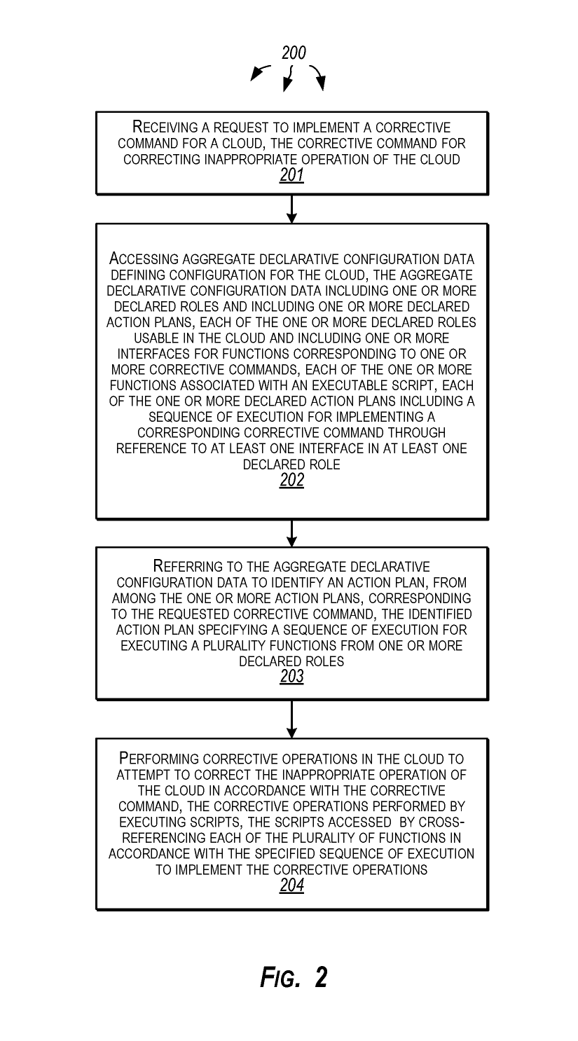

FIG. 2 illustrates a flow chart of an example method for configuring a cloud from aggregate declarative configuration data. Method 200 will be described with respect to the components and data of computer architecture 100.

Maintenance module 152 can receive error 153 from cloud 103. Error 153 indicates that inappropriate or unintended operations have occurred and/or are occurring in cloud 103. Inappropriate or unintended operations can include hardware or software malfunctions on the resources allocated to cloud 103. Maintenance module 152 can indicate error 153 to entity 104.

Method 200 includes receiving a request to implement a corrective command for a cloud, the corrective command for correcting inappropriate operation of the cloud (201). For example, maintenance module 152 can receive corrective command 151 from entity 104. Corrective command 151 can be a request to correct inappropriate operation within cloud 103 (as indicated by error 153). Entity 104 can submit corrective command 151 to maintenance module 152 in response to error 153.

Method 200 includes accessing aggregate declarative configuration data defining configuration for the cloud, the aggregate declarative configuration data including one or more declared roles and including one or more declared action plans, each of the one or more declared roles usable in the cloud and including one or more interfaces for functions corresponding to one or more corrective commands, each of the one or more functions associated with an executable script, each of the one or more declared action plans including a sequence of execution for implementing a corresponding corrective command through reference to at least one interface in at least one declared role (202). For example, maintenance module 152 can access aggregate configuration data 121. Aggregate configuration data 121 can define configuration for cloud 103. Aggregate configuration data 121 includes roles 122 and action plans 132. Roles 122 includes role 122A, role 122B, etc. Action plans 132 includes actions plans 132A, 132B, etc.

Each of roles 122 is useable in cloud 103 and includes one or more interfaces for functions corresponding to one or more corrective commands. For example, role 122A includes interface 123A and script reference 124A, interface 126A and script reference 127A, etc. Similarly, role 122B includes interface 123B and script reference 124B, interface 126B and script reference 127B, etc. Script references refer to scripts that can be executed to implement functions corresponding to corrective commands. In one aspect, one or more different corrective commands use the same interfaces. As such, the one or more different corrective commands can refer to at least some of the same scripts.

Each of action plans 132 can include a sequence of execution for implementing a corresponding corrective command (e.g., a from among bootstrap, reset, and recover) through reference to at least one interface in at least one declared role. For example, action plan 132A includes command type 133A and sequence 134A. Command type 133A corresponds to a specified type of corrective command (e.g., bootstrap, reset, or recover). Sequence 134A defines a sequence of execution for executing interface types 136A, 137A, etc. to implement the specified type of corrective command in cloud 103. Similarly, action plan 132B includes command type 133B and sequence 134B. Command type 133B corresponds to another specified type of corrective command (e.g., a different corrective command from among bootstrap, reset, and recover). Sequence 134B defines a sequence of execution for executing interface types 136B, 137B, etc. to implement the other specified type of corrective command in cloud 103.

Method 200 includes referring to the aggregate declarative configuration data to identify an action plan, from among the one or more action plans, corresponding to the requested corrective command, the identified action plan specifying a sequence of execution for executing a plurality functions from one or more declared roles (203). For example, maintenance module 152 can refer to aggregate configuration data 121 to identify action plan 132A corresponding to corrective command 151. As depicted action plan 132A specifies sequence 134A for executing functions from one or more of roles 122. Sequence 134A specifies an order of execution that accounts for dependencies between components associated with the functions indicated in sequence 134A.

Method 200 includes performing corrective operations in the cloud to attempt to correct the inappropriate operation of the cloud in accordance with the corrective command, the corrective operations performed by executing scripts, the scripts accessed by cross-referencing each of the plurality of functions in accordance with the specified sequence of execution to implement the corrective operations (204). For example, maintenance module 152 can perform corrective operations 154 in cloud 103 to attempt to correct inappropriate operation indicated by error 153. Maintenance module 152 can perform corrective operations 154 by executing scripts in accordance with sequence 134A.

For example, maintenance module 152 can execute script 111A. Maintenance module 152 can locate script 111A by cross-referencing interface type 136A to interface 126A and using script reference 127A to script 111A. Next, in accordance with sequence 134A, configuration engine 102 can execute script 111B. Configuration engine 102 can locate script 111B by cross-referencing interface type 137A to interface 126B and using script reference 127B to script 111B.

Additional scripts can be located and executed in accordance with sequence 134A. Sequence 134A can include executing at least some scripts in parallel (e.g., when the results of scripts do not depend on one another). Due to dependencies, other scripts can be executed serially.

As described, implementing corrective operations 154 through execution of scripts 111A, 111B, etc. can attempt to correct inappropriate and/or unintended operation of cloud 103 indicated by error 153. For example, execution of scripts 111A, 111B, etc. can bootstrap cloud 103, reset cloud 103, or initiate a recovery process for cloud 103. A bootstrap command can stop and restart one or more components within cloud 103. A reset command can reset cloud 103 to an initial deployment state. A recovery process can revert cloud 103 to a prior known state that may be later than an initial deployment state.

Implementation of a corrective command can include changing hardware resources and/or software resources used in cloud 103. For example, compute resources 106B can and storage resources 107A can be deallocated from cloud 103. Network resources 108B can be reset. Software component 112B can be run in cloud 103.

Accordingly, appropriate and/or intended operation of cloud 103 can be restored without altering the code of maintenance module 152 or configuration engine 102.

In one aspect, aggregate configuration data 121 declares a software defined configuration for a portion of networking resources 108 and/or declares a software defined configuration for a portion of storage resources 107.

Aggregate configuration data 121 can also declare complete physical and logical topology declarations for cloud 103.

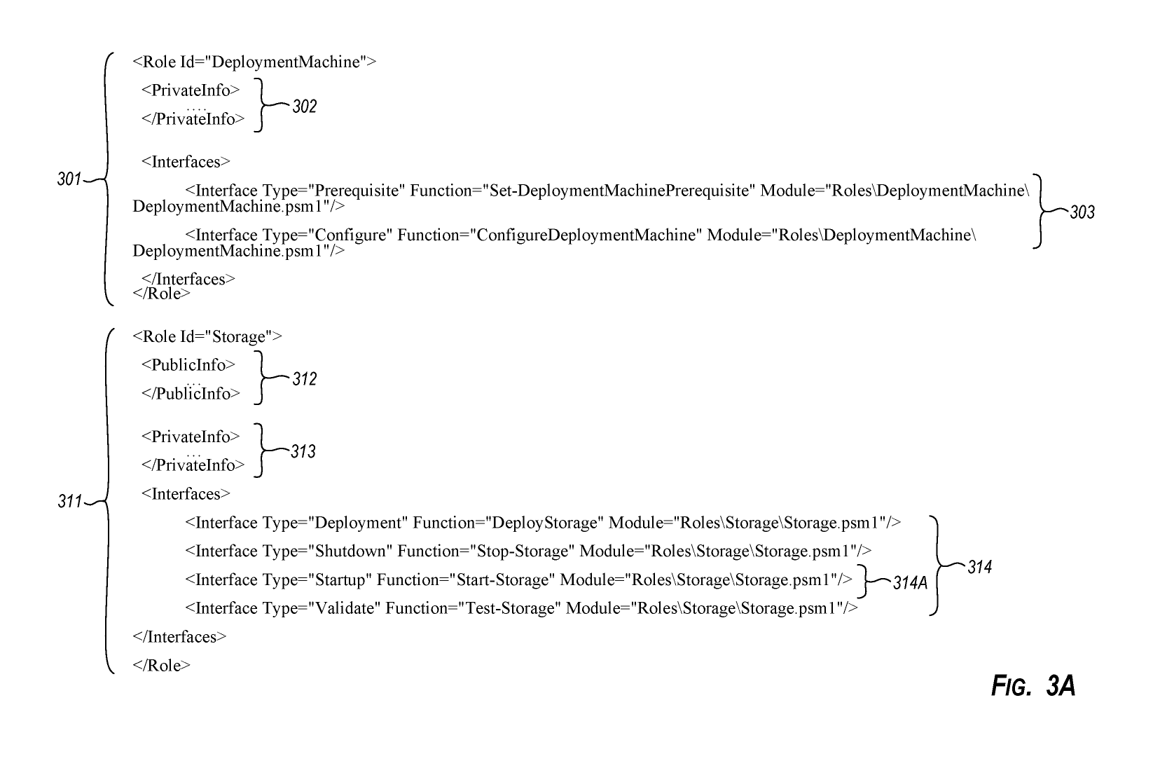

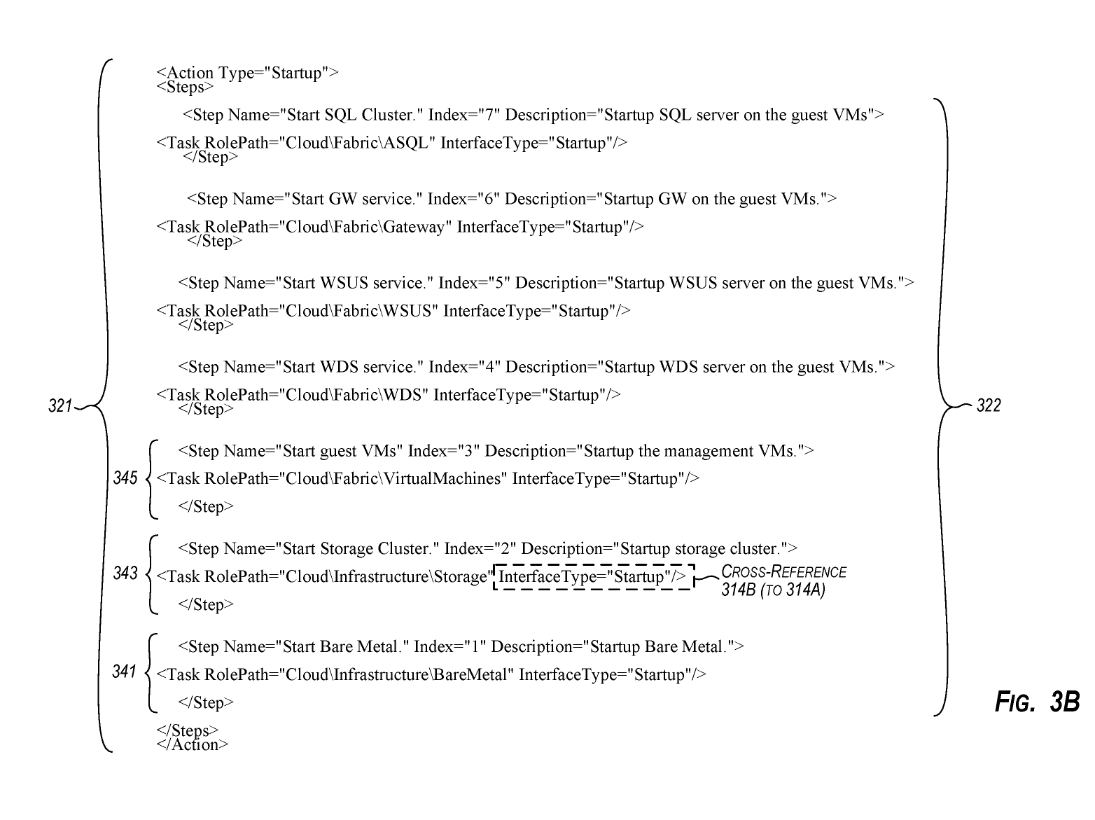

FIGS. 3A and 3B illustrate example aggregate declarative configuration data.

FIG. 3A depicts roles 301 and 311 (e.g., that can be included in aggregate configuration data 221). Role 301 is a role for deploying a machine. Role 301 includes private information 302 and interfaces 303. Private information 302 can be configuration information that is private to the developer of role 301 (and is unlikely to vary between different instances of role 301). Each of interfaces 303 include an interface type, a function, and a module (script reference).

Role 311 is a role for storage. Role 311 includes private information 312, public information 313, and interfaces 314. Private information 312 can be configuration information that is private to the developer of role 311 (and is unlikely to vary between different instances of role 311). Public information 313 can be configuration information that is modifiable by an entity using role 311 in a cloud. Public information 313 can modified by an entity to tailor role 311 for use in a particular cloud infrastructure. Each of interfaces 313 include an interface type, a function, and a module (script reference).

As described, role 301 and 311 can be included in aggregate declarative configuration data for a cloud. Roles 301 and 311 can be developed by different developers and can also be stored in different locations and/or files. For example, role 301 can be declared by machine developer and role 311 can be declared by a storage developer. However, the different developers can declare roles 301 and 311 in compliance with a declaration model. Compliance with the declaration model allows action plans to appropriately access interface types declared within roles even when the roles are declared by different developers.

Private information in a role can include a variety of different information including but not limited to: execution context, default gateways, account information, login credentials, timeout values, storage pool names, directory paths, certificate names, certificate authorities, etc. Public information in a role can also include a variety of different information including but not limited to: network addresses, stock keeping units (SKUs), cluster names, file server names, time servers, account quotas, Domain Name Services (DNS) information, port mappings, installation features, instance names, etc.

FIG. 3B depicts action plan 321 (e.g., that can be included in aggregate configuration data 321). Action plan 321 can be for a reset action (command) (a corrective command to reset a cloud to an initial state). Action plan 321 includes steps 322 (a sequence) for executing tasks. Step 341 (index=1) can be executed first to “Startup Bare Metal”. Step 343 (index=2) can be executed next to “Startup Storage Cluster”. Step 345 (index=3) can be executed next to “Startup the Management VMs (virtual machines). Other steps can subsequently be executed by index number to start up various components on guest VMs (virtual machines)

Each step in steps 322 can cross-reference an interface type of a role. For example, step 343 includes cross-reference 314 that cross-references a “Startup” interface type 314A for Storage. Referring back to FIG. 3A, interface type 314A is included in interfaces 314. Thus, a maintenance module (e.g., maintenance module 152) can process step 343 to implement a start storage function by executing Roles\Storage\Storage.psm1.

In one aspect, a system includes a processor, system memory, storage resources, and a maintenance module. The maintenance module can use the processor to receive a request to implement a corrective command for a cloud. The corrective command is for correcting inappropriate operation of the cloud.

The maintenance module can use the processor to access aggregate declarative configuration data defining configuration for the cloud. The aggregate declarative configuration data includes one or more declared roles and including one or more declared action plans. Each of the one or more declared roles is usable in the cloud and includes one or more interfaces for functions corresponding to one or more corrective commands Each of the one or more functions is associated with an executable script. Each of the one or more declared action plans includes a sequence of execution for implementing a corresponding corrective command through reference to at least one interface in at least one declared role.

The maintenance module can use the processor to refer to the aggregate declarative configuration data to identify an action plan, from among the one or more action plans, corresponding to the requested corrective command. The identified action plan specifies a sequence of execution for executing a plurality functions from one or more declared roles.

The maintenance module can use the processor to perform corrective operations in the cloud to attempt to correct the inappropriate operation of the cloud in accordance with the corrective command. The corrective operations are performed by executing scripts. The scripts are accessed by cross-referencing each of the plurality of functions in accordance with the specified sequence of execution to implement the corrective operations.

In another aspect, a method for resolving inappropriate operation of a cloud is performed. A request to implement a corrective command for a cloud is received. The corrective command is for correcting inappropriate operation of the cloud.

Aggregate declarative configuration data defining configuration for the cloud is accessed. The aggregate declarative configuration data includes one or more declared roles and including one or more declared action plans. Each of the one or more declared roles is usable in the cloud and includes one or more interfaces for functions corresponding to one or more corrective commands Each of the one or more functions is associated with an executable script. Each of the one or more declared action plans includes a sequence of execution for implementing a corresponding corrective command through reference to at least one interface in at least one declared role.

The aggregate declarative configuration data is referred to to identify an action plan, from among the one or more action plans, corresponding to the requested corrective command. The identified action plan specifying a sequence of execution for executing a plurality functions from one or more declared roles. Corrective operations are performed in the cloud to attempt to correct the inappropriate operation of the cloud in accordance with the corrective command. The corrective operations are performed by executing scripts. The scripts are accessed by cross-referencing each of the plurality of functions in accordance with the specified sequence of execution to implement the corrective operations.

In a further aspect, a computer program product for use at a computer system includes one or more computer storage devices having stored thereon computer-executable instructions that, in response to execution at a processor, cause the computer system to implement a method for resolving inappropriate operation of a cloud.

The computer program product includes computer-executable instructions that, in response to execution at a processor, cause the computer system to receive a request to implement a corrective command for a cloud. The corrective command is for correcting inappropriate operation of the cloud.

The computer program product includes computer-executable instructions that, in response to execution at a processor, cause the computer system to access aggregate declarative configuration data defining configuration for the cloud. The aggregate declarative configuration data includes one or more declared roles and including one or more declared action plans. Each of the one or more declared roles is usable in the cloud and includes one or more interfaces for functions corresponding to one or more corrective commands Each of the one or more functions is associated with an executable script. Each of the one or more declared action plans includes a sequence of execution for implementing a corresponding corrective command through reference to at least one interface in at least one declared role.

The computer program product includes computer-executable instructions that, in response to execution at a processor, cause the computer system to refer to the aggregate declarative configuration data to identify an action plan, from among the one or more action plans, corresponding to the requested corrective command. The identified action plan specifies a sequence of execution for executing a plurality functions from one or more declared roles.

The computer program product includes computer-executable instructions that, in response to execution at a processor, cause the computer system to perform corrective operations in the cloud to attempt to correct the inappropriate operation of the cloud in accordance with the corrective command. The corrective operations are performed by executing scripts. The scripts are accessed by cross-referencing each of the plurality of functions in accordance with the specified sequence of execution to implement the corrective operations.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A system, the system comprising:
one or more processors, the one or more processors providing compute resources;
networking resources;
storage resources;
system memory coupled to one or more processors, the system memory storing instructions that are executable by the processor; and
the one or more processors executing the instructions stored in the system memory to:
receive a request to implement a corrective command for a cloud, the corrective command for correcting inappropriate operation of the cloud;
access aggregate declarative configuration data defining configuration for the cloud, the aggregate declarative configuration data including one or more declared roles and including one or more declared action plans, each of the one or more declared roles usable in the cloud and including one or more interfaces for functions corresponding to one or more corrective commands, each of the one or more functions associated with an executable script, each of the one or more declared action plans including a sequence of execution for implementing a corresponding corrective command through reference to at least one interface in at least one declared role;
refer to the aggregate declarative configuration data to identify an action plan, from among the one or more action plans, corresponding to the requested corrective command, the identified action plan specifying a sequence of execution for executing a plurality functions from one or more declared roles; and
perform corrective operations in the cloud to attempt to correct the inappropriate operation of the cloud in accordance with the corrective command, the corrective operations performed by executing scripts, the scripts accessed by cross-referencing each of the plurality of functions in accordance with the specified sequence of execution to implement the corrective operations.

2. The system of claim 1, wherein executing the instructions to receive a request to implement a corrective command for a cloud, the corrective command for correcting inappropriate operation of the cloud comprises executing the instructions to receive a request to implement one of: a bootstrap command, a recovery command, or a reset command, for the cloud.

3. The system of claim 1, wherein executing the instructions to access aggregate declarative configuration data defining configuration for the cloud comprises executing the instructions to access aggregate configuration data that includes, for at least one declared role, one or more of: software defined configuration for a portion of the networking resources and software defined configuration for a portion of the storage resources.

4. The system of claim 1, wherein executing the instructions to access aggregate declarative configuration data defining configuration for the cloud comprises executing the instructions to accessing aggregate configuration data that includes complete physical and logical topology declarations for the cloud.

5. The system of claim 1, wherein executing the instructions to access aggregate declarative configuration data defining configuration for the cloud comprises executing the instructions to access aggregate configuration data that defines an action plan for each of: a bootstrap command, a recovery command, and a reset command, for the cloud.

6. The system of claim 1, wherein executing the instructions to access aggregate declarative configuration data defining configuration for the cloud comprises executing the instructions to access aggregate configuration data that declares how to configure the networking resources, the storage resources, and the processor resources when implementing the corrective command.

7. The system of claim 1, wherein executing the instructions to perform corrective operations in the cloud to attempt to correct the inappropriate operation of the cloud in accordance with the corrective command comprises executing the instructions to execute scripts by cross-referencing each of the plurality of functions in accordance with the specified sequence of execution to implement one of: a bootstrap command, a recovery command, or a reset command, for the cloud.

8. The system of claim 1, wherein the cloud is a hybrid cloud.

9. A method for use at a computer system, the computer system including a processor, the method for resolving inappropriate operation of a cloud, the method comprising the processor:
receiving a request to implement a corrective command for a cloud, the corrective command for correcting inappropriate operation of the cloud;
accessing aggregate declarative configuration data defining configuration for the cloud, the aggregate declarative configuration data including one or more declared roles and including one or more declared action plans, each of the one or more declared roles usable in the cloud and including one or more interfaces for functions corresponding to one or more corrective commands, each of the one or more functions associated with an executable script, each of the one or more declared action plans including a sequence of execution for implementing a corresponding corrective command through reference to at least one interface in at least one declared role;
referring to the aggregate declarative configuration data to identify an action plan, from among the one or more action plans, corresponding to the requested corrective command, the identified action plan specifying a sequence of execution for executing a plurality functions from one or more declared roles; and
performing corrective operations in the cloud to attempt to correct the inappropriate operation of the cloud in accordance with the corrective command, the corrective operations performed by executing scripts, the scripts accessed by cross-referencing each of the plurality of functions in accordance with the specified sequence of execution to implement the corrective operations.

10. The method of claim 9, wherein receiving a request to implement a corrective command for a cloud comprises receiving a request to implement one of: a bootstrap command, a recovery command, or a reset command, for the cloud.

11. The method of claim 9, wherein receiving a request to implement a corrective command for a cloud comprises receiving a request to implement a corrective command for a hybrid cloud.

12. The method of claim 9, wherein accessing declarative aggregate configuration data defining configuration for the cloud comprises accessing aggregate configuration data defining configuration for a hybrid cloud.

13. The method of claim 9, wherein accessing aggregate declarative configuration data defining configuration for the cloud comprises accessing aggregate configuration data that includes one or more of: software defined networking for the cloud and software defined storage for the cloud.

14. The method of claim 9, wherein accessing aggregate declarative configuration data defining configuration for the cloud comprises accessing aggregate configuration data that includes complete physical topology declarations and logical topology declarations for the cloud.

15. The method of claim 9, wherein accessing aggregate declarative configuration data comprises accessing extended aggregate declarative configuration data defining a cloud for an entity, the extended aggregate declarative configuration data extending the aggregate declarative configuration data to tailor implementation of corrective commands for use by the entity.

16. The method of claim 9, wherein accessing declarative aggregate configuration data defining configuration for the cloud comprises accessing aggregate configuration data that declares how to configure network resources, storage resources, and processor resources when implementing the corrective command.

17. The method of claim 9, wherein accessing aggregate declarative configuration data defining configuration for the cloud comprises accessing aggregate configuration data that defines an action plan for each of: a bootstrap command, a recovery command, and a reset command, for the cloud.

18. The method of claim 9, wherein performing corrective operations in the cloud to attempt to correct the inappropriate operation of the cloud in accordance with the corrective command comprises executing scripts by cross-referencing the functions in accordance with the specified sequence of execution to implement one of: a bootstrap command, a recovery command, or a reset command, within a hybrid cloud.

19. A computer program product for use at a computer system, the computer program product for implementing a method for resolving inappropriate operation of a cloud, the method comprising one or more computer storage devices having stored thereon computer-executable instructions that, when executed at a processor, cause the computer system to implement the method, including the following:
receive a request to implement a corrective command for a cloud, the corrective command for correcting inappropriate operation of the cloud;
access aggregate declarative configuration data defining configuration for the cloud, the aggregate declarative configuration data including one or more declared roles and including one or more declared action plans, each of the one or more declared roles usable in the cloud and including one or more interfaces for functions corresponding to one or more corrective commands, each of the one or more functions associated with an executable script, each of the one or more declared action plans including a sequence of execution for implementing a corresponding corrective command through reference to at least one interface in at least one declared role;
refer to the aggregate declarative configuration data to identify an action plan, from among the one or more action plans, corresponding to the requested corrective command, the identified action plan specifying a sequence of execution for executing a plurality functions from one or more declared roles; and
perform corrective operations in the cloud to attempt to correct the inappropriate operation of the cloud in accordance with the corrective command, the corrective operations performed by executing scripts, the scripts accessed by cross-referencing each of the plurality of functions in accordance with the specified sequence of execution to implement the corrective operations.

20. The computer program product of claim 19, wherein computer-executable instructions that, when executed, cause the computer system to perform corrective operations in the cloud to attempt to correct the inappropriate operation of the cloud in accordance with the corrective command comprise computer-executable instructions that, when executed, cause the computer system to execute scripts by cross-referencing each of the plurality of functions in accordance with the specified sequence of execution to implement one of: a bootstrap command, a recovery command, or a reset command, within a hybrid cloud.
